(19) United States
(12) Patent Application Publication
(10) Pub. No.: US 2026/0062043 A1
(43) Pub. Date: Mar. 5, 2026

(54) COLLAPSIBLE LUGGAGE TRANSPORTION DEVICE

(71) Applicants: Sonia V. Hills, Fort Walton Beach, FL (US); Thomas L. Hills, Fort Walton Beach, FL (US)

(72) Inventors: Sonia V. Hills, Fort Walton Beach, FL (US); Thomas L. Hills, Fort Walton Beach, FL (US)

(21) Appl. No.: 18/822,709

(22) Filed: Sep. 3, 2024

(51) Int. Cl. B62B 3/02; B62B 3/00; B62B 5/06

(52) U.S. Cl. CPC B62B 3/022; B62B 3/002; B62B 5/067

(57) ABSTRACT

A collapsible device for the transportation of luggage and other bulkier items is disclosed. The device includes a frame defining a rectilinear surface for holding and retaining luggage and other bulkier items; a plurality of casters operatively connected underneath the frame and positioned to optimize transportability and navigability of the device; a telescoping handle connected to one end of the frame, the telescoping handle extending outwardly from the frame and configured to facilitate pulling and steering of the device; and a retaining surface connected to an opposite end of the frame, the retaining surface operatively configured to physically hold and retain the luggage and other bulkier items.

### TECHNICAL FIELD

The present invention relates to a luggage transportation device. More specifically, the present invention relates to a collapsible cart for towing luggage and other bulky items.

### BACKGROUND

Luggage carts and other devices for transporting luggage and other bulky items, such as bankers' boxes or children's strollers, are known in the art.

For example, U.S. Pat. No. 4,523,773 discloses a luggage cart upon which luggage may be placed with two wheels and a collapsible handlebar. One of the disadvantages of luggage carts like this and many others with two wheels is that they only can hold one piece of luggage and are not practicable for transporting larger, bulkier items.

As another example, U.S. Pat. No. 5,826,892 discloses a four-wheeled pushcart for luggage. Having four wheels generally provides for a larger carrying surface such that a four-wheeled cart can carry multiple pieces of luggage or larger, bulkier items. However, one of the disadvantages of many larger carts such as that disclosed in the '892 Patent is that the carts cannot be easily stowed after use or take up far too much space when stowed.

There remains a need in the art for luggage carts that are capable of carrying multiple pieces of luggage or larger, bulkier items, while still being capable of being stowed easily and in a smaller space.

### SUMMARY OF THE INVENTION

According to one non-limiting aspect of the present disclosure, an example embodiment of a collapsible luggage transportation device is disclosed. The collapsible device for the transportation of luggage and other bulkier items includes a frame defining a rectilinear surface for holding and retaining luggage and other bulkier items; a plurality of casters operatively connected underneath the frame and positioned to optimize transportability and navigability of the device; a telescoping handle connected to one end of the frame, the telescoping handle extending outwardly from the frame and configured to facilitate pulling and steering of the device; and a retaining surface connected to an opposite end of the frame, the retaining surface operatively configured to physically hold and retain the luggage and other bulkier items.

According to another non-limiting aspect of the present disclosure, another example embodiment of a collapsible luggage transportation device is disclosed. The collapsible device for the transportation of luggage and other bulkier items includes a frame having two halves defining a rectilinear surface for holding and retaining luggage and other bulkier items, each half of the frame joined together by at least one hinge; a plurality of casters operatively connected underneath the frame and positioned to optimize transportability and navigability of the device; a telescoping handle connected to one end of the frame, the telescoping handle extending outwardly from the frame and configured to facilitate pulling and steering of the device; and a retaining surface connected to an opposite end of the frame, the retaining surface operatively configured to physically hold and retain the luggage and other bulkier items Additional features and advantages are described herein, and will be apparent from the following Detailed Description and the figures.

### BRIEF DESCRIPTION OF THE DRAWINGS

Features and advantages of the system and method described herein may be better understood by reference to the accompanying drawings in which:

FIG. 1 is a perspective view of one embodiment of the collapsible luggage transportation device described and claimed in the present disclosure, when the device is unfolded and ready for use;

FIG. 2 is side view of the collapsible luggage transportation device of FIG. 1, when the device is unfolded and ready for use;

FIG. 3 is a perspective view of the collapsible luggage transportation device of FIG. 1, when the device is folded up for storage or stowage;

FIG. 4 is a side view of the collapsible luggage transportation device of FIG. 1, when the device is folded up for storage or stowage;

FIG. 5 is a perspective view of another embodiment of the collapsible luggage transportation device described and claimed in the present disclosure, when the device is unfolded and ready for use;

FIG. 6 is side view of the collapsible luggage transportation device of FIG. 5, when the device is unfolded and ready for use;

FIG. 7 is a perspective view of the collapsible luggage transportation device of FIG. 5, when the device is folded up for storage or stowage;

FIG. 8 is a side view of the collapsible luggage transportation device of FIG. 5, when the device is folded up for storage or stowage;

A skilled artisan will appreciate the foregoing details, as well as others, upon considering the following Detailed Description of certain non-limiting embodiments of the collapsible luggage transportation devices according to the present disclosure. One of ordinary skill also may comprehend certain of such additional details upon using system and method described herein.

### DETAILED DESCRIPTION

The present invention comprises a luggage transportation device. More specifically, the present invention comprises a collapsible cart for towing luggage and other bulky items.

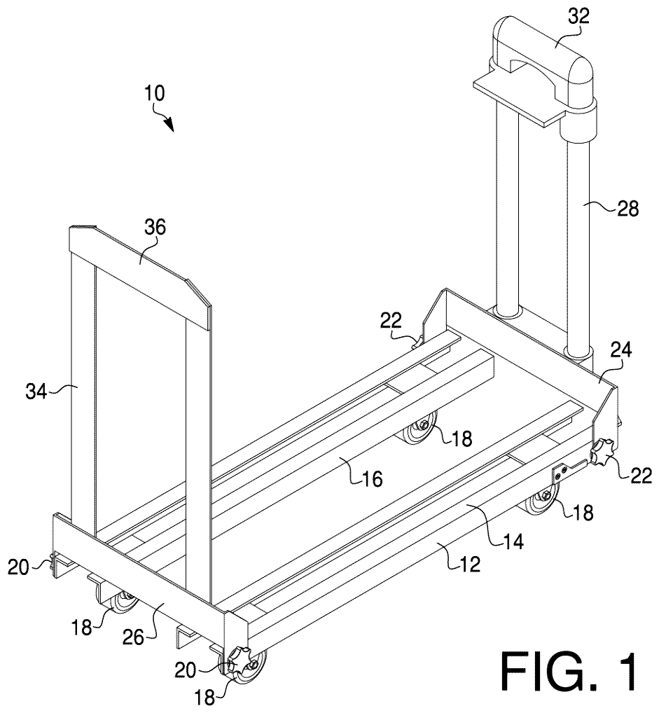

As shown in FIG. 1, a perspective view of one embodiment of the collapsible luggage transportation device 10 described and claimed in the present disclosure is shown, when the device is unfolded and ready for use.

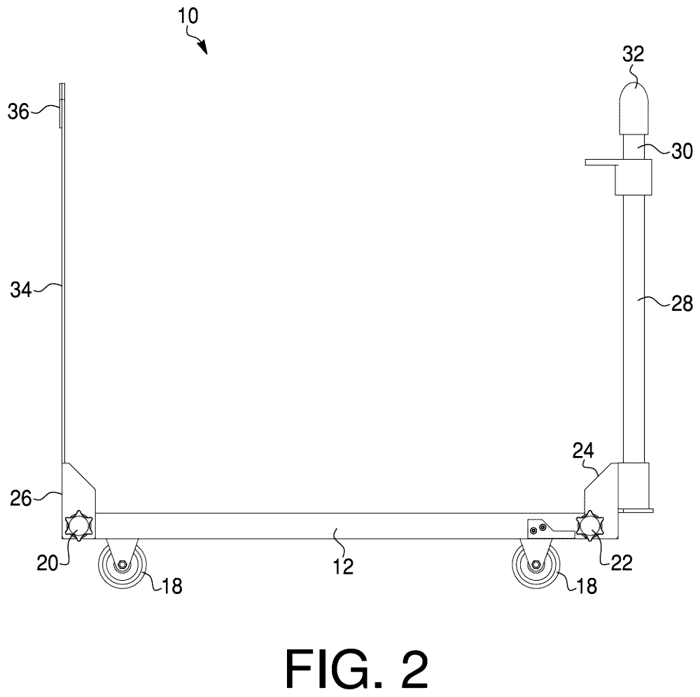

With regard to the reference numerals shown in FIGS. 1 and 2, the collapsible luggage transportation device or cart 10 includes a generally rectangular-shaped frame 12 having longitudinal support members 14 and 16 for rigidness, structural integrity of the frame 12 and to support the luggage and other bulky items transported on the cart 10. The frame 12 also includes a plurality of casters 18, which may be fixed or locking or may be rotational, or some combination thereof.

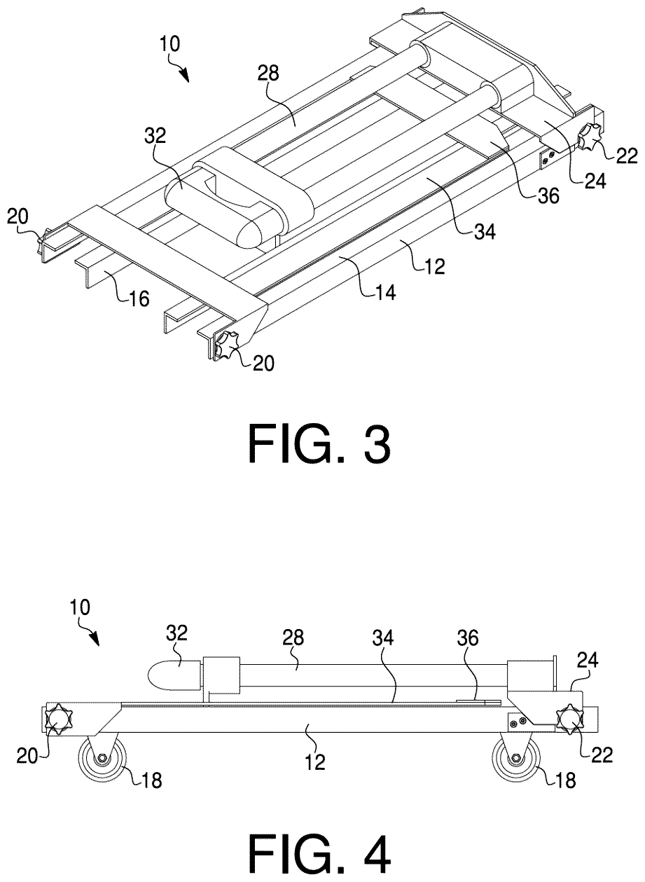

The frame 12 includes rotating locking nuts 20 and 22, which may be turned counterclockwise to loosen or clockwise to tighten. By loosening the locking nuts 20, 22, side members 24, 26 can rotate up to ninety degrees to allow the cart 10 to move from an open or operational position, as shown in FIG. 1, to a closed or stowed position, as shown in FIGS. 3 and 4.

In specific, turning locking nut 20 counterclockwise loosens the locking nut and allows side member 26 to pivot inwardly towards frame 12, as may be desirable for stowing or storing the cart 10 in a confined space, such as an overhead bin on a commercial airplane. When side member 26 pivots fully into frame 12 such that it is parallel to and on top of frame 12, the locking nut 20 can be turned clockwise to tighten, so as to lock the side member 26 into the stowed position.

Similarly, turning locking nut 22 counterclockwise loosens the locking nut and allows side member 24 to pivot inwardly towards frame 12, as may be desirable to place the cart 10 into a stowed position. When side member 24 pivots fully into frame 12 such that it is parallel to and on top of frame 12, the locking nut 20 can be turned clockwise to tighten, so as to lock the side member 24 into the stowed position.

Side member 24 includes a telescoping handle 28 that comprises an internally telescoping upper portion 30 to which a handle 32 is affixed. The telescoping handle 28 extends from side member 24 to approximately waist level of a person pulling cart 10 for ease with moving and steering cart 10. The telescoping handle 28 retracts downwardly towards side member 24 for stowage.

Side member 26 includes a retaining bar 34 with an upper extension bar 36 for holding and retaining the luggage and/or other bulkier items being transported on cart 10.

In use, cart 10 provides for the easy transportation of luggage and bulkier items, such as strollers, by one person, while also allowing the cart 10 to be folded up into a size that is easy to carry and fits within a vehicle truck or back seat or in the overhead compartment on a commercial airliner.

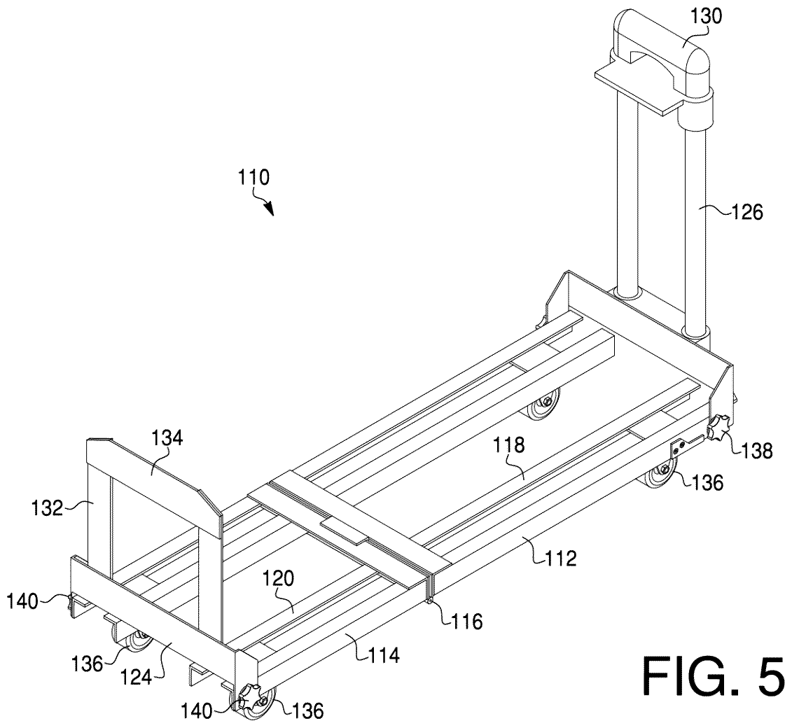

As shown in FIG. 5, a perspective view of another embodiment of the collapsible luggage transportation device described and claimed in the present disclosure is shown, when the device is unfolded and ready for use.

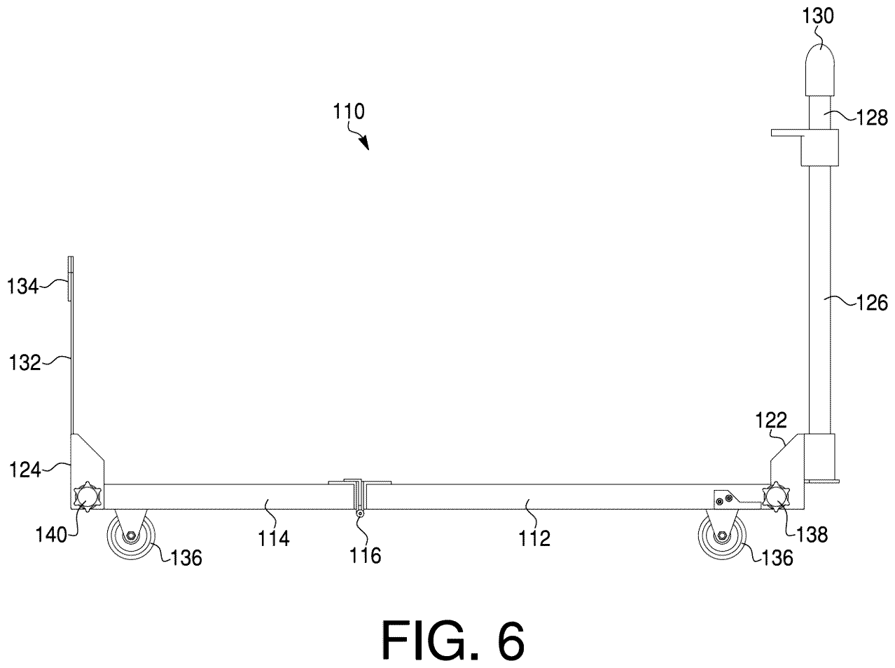

With regard to the reference numerals shown in FIGS. 5 and 6, the collapsible luggage transportation device or cart 110 includes generally rectangular-shaped frame portions 112 and 114 that are connected to one another by a pair of hinges 116. The frame portions 112 and 114 also include longitudinal structural members 118 and 120, which provide rigidity to the frame members while also supporting the weight of luggage or other bulkier items placed on the frame portions. The frame portions 112 and 114 also include a plurality of casters 136, which may be fixed or locking or may be rotational, or some combination thereof.

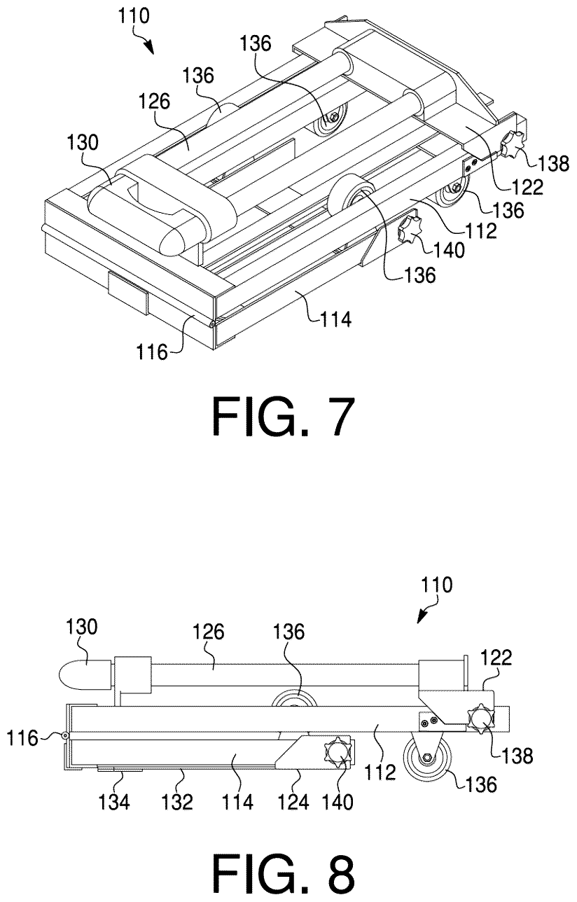

The frame portion 112 includes rotating locking nut 138, which may be turned counterclockwise to loosen or clockwise to tighten. By loosening the locking nut 138, side member 122 can rotate up to ninety degrees to allow the cart 110 to move from an open or operational position, as shown in FIG. 5, to a closed or stowed position, as shown in FIGS. 7 and 8.

In specific, turning locking nut 138 counterclockwise loosens the locking nut and allows side member 122 to pivot inwardly towards frame portion 112, as may be desirable for stowing or storing the cart 110 in a confined space, such as an overhead bin on a commercial airplane. When side member 122 pivots fully into frame portion 112 such that it is parallel to and on top of frame portion 112, the locking nut 138 can be turned clockwise to tighten, so as to lock the side member 122 into the stowed position.

Similarly, turning locking nut 138 counterclockwise loosens the locking nut and allows side member 122 to pivot inwardly towards frame portion 112, as may be desirable to place the cart 110 into a stowed position. When side member 122 pivots fully into frame portion 112 such that it is parallel to and on top of frame portion 112, the locking nut 138 can be turned clockwise to tighten, so as to lock the side member 122 into the stowed position.

Similarly, the frame portion 114 includes rotating locking nut 140, which may be turned counterclockwise to loosen or clockwise to tighten. By loosening the locking nut 140, side member 124 can rotate up to ninety degrees to allow the cart 110 to move from an open or operational position, as shown in FIG. 5, to a closed or stowed position, as shown in FIGS. 7 and 8.

In specific, turning locking nut 140 counterclockwise loosens the locking nut and allows side member 124 to pivot inwardly towards frame portion 114, as may be desirable for stowing or storing the cart 110 in a confined space, such as an overhead bin on a commercial airplane. When side member 124 pivots fully into frame portion 114 such that it is parallel to and on top of frame portion 114, the locking nut 140 can be turned clockwise to tighten, so as to lock the side member 124 into the stowed position.

Similarly, turning locking nut 140 counterclockwise loosens the locking nut and allows side member 124 to pivot inwardly towards frame portion 114, as may be desirable to place the cart 110 into a stowed position. When side member 124 pivots fully into frame portion 114 such that it is parallel to and on top of frame portion 114, the locking nut 140 can be turned clockwise to tighten, so as to lock the side member 124 into the stowed position.

Side member 122 includes a telescoping handle 126 that comprises an internally telescoping upper portion 128 to which a handle 130 is affixed. The telescoping handle 126 extends from side member 122 to approximately waist level of a person pulling cart 110 for ease with moving and steering cart 110. The telescoping handle 126 retracts downwardly towards side member 122 for stowage.

Side member 124 includes a retaining bar 132 with an upper extension bar 134 for holding and retaining the luggage and/or other bulkier items being transported on cart 110.

In use, cart 110 provides for the easy transportation of luggage and bulkier items, such as strollers, by one person, while also allowing the cart 110 to be folded up into a size that is easy to carry and fits within a vehicle truck or back seat or in the overhead compartment on a commercial airliner.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method illustrated herein can be made by those skilled in the art without departing from the spirit and scope of this invention.

It is therefore intended that such changes and modifications be covered by the appended set of claims.

What is claimed is:

1. A collapsible device for the transportation of luggage and other bulkier items comprising:
a frame defining a rectilinear surface for holding and retaining luggage and other bulkier items;
a plurality of casters operatively connected underneath the frame and positioned to optimize transportability and navigability of the device;
a telescoping handle connected to one end of the frame, the telescoping handle extending outwardly from the frame and configured to facilitate pulling and steering of the device; and
a retaining surface connected to an opposite end of the frame, the retaining surface operatively configured to physically hold and retain the luggage and other bulkier items.

2. The device of claim 1 wherein the side of the device that includes the telescoping handle is rotatably connected to the frame with a locking mechanism such that the side can be unlocked and rotated inwardly with the telescoping handle towards the frame.

3. The device of claim 2 wherein the locking mechanism comprises a rotating locking knob that is configured to rotate in one direction to loosen and in the opposite direction to tighten, wherein loosening the rotating locking knob allows the side to rotatably pivot about the frame.

4. The device of claim 3 wherein the rotating locking knob can be tightened when the side is fully rotated into the frame to provide for stowage of the device.

5. The device of claim 1 wherein the telescoping handle includes an upper portion and a lower portion, the upper portion configured to slide within the lower portion, such that the telescoping handle can extend outwardly from the device.

6. The device of claim 1 wherein the side of the device that includes the retaining surface is rotatably connected to the frame with a locking mechanism such that the side can be unlocked and rotated inwardly with the retaining surface towards the frame.

7. The device of claim 6 wherein the locking mechanism comprises a rotating locking knob that is configured to rotate in one direction to loosen and in the opposite direction to tighten, wherein loosening the rotating locking knob allows the side to rotatably pivot about the frame.

8. The device of claim 7 wherein the rotating locking knob can be tightened when the side is fully rotated into the frame to provide for stowage of the device.

9. The device of claim 1 wherein the telescoping handle is configured to rotate inwardly towards the frame and the retaining surface is configured to rotate inwardly towards the frame, such that the device collapses upon itself for stowage.

10. A collapsible device for the transportation of luggage and other bulkier items comprising:
a frame having two halves defining a rectilinear surface for holding and retaining luggage and other bulkier items, each half of the frame joined together by at least one hinge;
a plurality of casters operatively connected underneath the frame and positioned to optimize transportability and navigability of the device;
a telescoping handle connected to one end of the frame, the telescoping handle extending outwardly from the frame and configured to facilitate pulling and steering of the device; and
a retaining surface connected to an opposite end of the frame, the retaining surface operatively configured to physically hold and retain the luggage and other bulkier items.

11. The device of claim 10 wherein the two halves of the frame are configured to fold onto one another wherein one half is on top of and parallel to the other half.

12. The device of claim 10 wherein the side of the device that includes the telescoping handle is rotatably connected to the frame with a locking mechanism such that the side can be unlocked and rotated inwardly with the telescoping handle towards the frame.

13. The device of claim 12 wherein the locking mechanism comprises a rotating locking knob that is configured to rotate in one direction to loosen and in the opposite direction to tighten, wherein loosening the rotating locking knob allows the side to rotatably pivot about the frame.

14. The device of claim 13 wherein the rotating locking knob can be tightened when the side is fully rotated into the frame to provide for stowage of the device.

15. The device of claim 10 wherein the telescoping handle includes an upper portion and a lower portion, the upper portion configured to slide within the lower portion, such that the telescoping handle can extend outwardly from the device.

16. The device of claim 10 wherein the side of the device that includes the retaining surface is rotatably connected to the frame with a locking mechanism such that the side can be unlocked and rotated inwardly with the retaining surface towards the frame.

17. The device of claim 16 wherein the locking mechanism comprises a rotating locking knob that is configured to rotate in one direction to loosen and in the opposite direction to tighten, wherein loosening the rotating locking knob allows the side to rotatably pivot about the frame.

18. The device of claim 17 wherein the rotating locking knob can be tightened when the side is fully rotated into the frame to provide for stowage of the device.

19. The device of claim 10 wherein the two halves of the frame are configured to fold onto one another such that one half is on top of and parallel to the other half, the telescoping handle being configured to rotate inwardly towards the frame, and the retaining surface being configured to rotate inwardly towards the frame, such that the device collapses upon itself for stowage.

20. The device of claim 19 wherein the plurality of casters reside at corners of the frame and nestle between the halves of the frame when the device is collapsed for stowage.
